(19) United States
(12) Patent Application Publication
(10) Pub. No.: US 2011/0291980 A1
(43) Pub. Date: Dec. 1, 2011

(54) TOUCH PANEL, TOUCH-DETECTING METHOD THEREOF AND DISPLAY APPARATUS WITH TOUCH FUNCTION

(75) Inventors: Yen-Feng LIN, Hsin-Chu (TW); Hao-Yuan Hou, Hsin-Chu (TW)

(73) Assignee: AU Optronics Corp.

(21) Appl. No.: 12/786,654

(22) Filed: May 25, 2010

(51) Int. Cl. G06F 3/041; G06F 3/045

(52) U.S. Cl. 345/174; 345/173

(57) ABSTRACT

A touch panel is adapted for detecting a touch location of a touch point. The touch panel comprises a substrate and at least one first-direction detecting device. The first-direction detecting device is arranged at a first direction of the substrate to detect a first-direction coordinate value of the touch point. Each first-direction detecting device comprises a first deformation sensor and a second deformation sensor. The first deformation sensor generates a shape variation in the first direction because of the touch point, and provides a first variation according to the shape variation. The second deformation sensor generates a shape variation in the first direction because of the touch point, and provides a second variation according to the shape variation. The first-direction coordinate value is determined by the first variation and the second variation.

### CROSS-REFERENCE TO RELATED APPLICATIONS

This application is based upon and claims the benefit of priority from the prior Taiwan Patent Application No. 098119991 filed Jun. 15, 2009, the entire contents of which are incorporated herein by reference.

### BACKGROUND

1. Technical Field

The present invention relates to the touch-detecting field, and more particularly to a touch panel, a touch-detecting method thereof and a display apparatus with touch function.

2. Description of the Related Art

With the rapid development of the technology, since flat display apparatus (such as, liquid crystal display apparatus) has many advantages, such as high definition, little size, light weight and wide application-range, it is widely applied into various electronic products, such as mobile phone, notebook computer, desktop display apparatus and television etc. Furthermore, the flat display apparatus has gradually substitute conventional cathode ray tube (CRT) display apparatus to be a main trend of the display apparatus.

Touch panel is configured for providing a new human-machine interface, and it is more intuitional in use and more suitable for the human nature. If the touch panel is integrated into the flat display apparatus, it can substitute conventional input device, and be more intuitional in use and more suitable for the human nature. However, the conventional technology of integrating the touch panel into the flat display apparatus, generally directly attaches the touch panel on the flat display apparatus. Furthermore, the sensors of the conventional touch panel are manufactured by overlying many layers of material. Therefore, the whole thickness of the touch panel can not be effectively decreased, and the whole thickness of the flat display apparatus can not be effectively decreased. Furthermore, the touch panel also reduces the light-penetrating ratio and other optical properties of the flat display apparatus, thus the visual effect of the flat display apparatus will be influenced.

In addition, the conventional touch panel mostly employs the flat printing technology or the coating technology to arrange the sensors manufactured by overlying many layers of the material on the whole touch panel. Therefore, if the manufacturers do not master the flat printing technology or the coating technology, they cannot enter the touch detecting field.

### SUMMARY

The present invention relates to a touch panel with a thin thickness and a lower cost.

The present invention also relates to a touch-detecting method adapted into the above touch panel.

The present invention further relates to a display apparatus with touch function, which has a thin thickness, a high light-penetrating ratio and other excellent optical properties.

A touch panel in accordance with an exemplary embodiment of the present invention is adapted for detecting a touch location of a touch point. The touch panel comprises a substrate and at least one first-direction detecting device. The first-direction detecting device is arranged at a first direction of the substrate to detect a first-direction coordinate value of the touch point. Each first-direction detecting device comprises a first deformation sensor and a second deformation sensor. The first deformation sensor generates a shape variation in the first direction because of generating the touch point, and provides a first variation because of the shape variation. The second deformation sensor generates a shape variation in the first direction because of generating the touch point, and provides a second variation because of the shape variation. The first-direction coordinate value is determined by the first variation and the second variation.

In an exemplary embodiment of the present invention, the touch panel further comprises at least one second-direction detecting device arranged at a second direction of the substrate to detect a second-direction coordinate value of the touch point. Each second-direction detecting device comprises a third deformation sensor and a fourth deformation sensor. The third deformation sensor generates a shape variation in the second direction because of generating the touch point, and provides a third variation because of the shape variation. The fourth deformation sensor generates a shape variation in the second direction because of generating the touch point, and provides a fourth variation because of the shape variation. The second-direction coordinate value is determined by the third variation and the fourth variation.

In an exemplary embodiment of the present invention, the first-direction coordinate value is determined by a ratio of the first variation and the second variation, and the second-direction coordinate value is determined by a ratio of the third variation and the fourth variation.

A touch panel adapted for detecting a touch location of an object in accordance with another exemplary embodiment of the present invention is provided. The touch panel comprises a substrate and a deformation pair arranged on the substrate. The deformation pair generates shape variations in a first direction when the object touches the touch panel. The touch panel judges the touch location in the first direction of the object touching the touch panel, according to a corresponding variation result generated by the shape variations of the deformation pair in the first direction.

In an exemplary embodiment of the present invention, the touch panel further comprises another deformation pair arranged at a second direction of the substrate to generate shape variations in the second direction when the object touches the substrate. The touch panel judges the touch location in the second direction of the object touching the touch panel, according to a corresponding variation result generated by the shape variations of the deformation pair in the second direction.

A touch-detecting method in accordance with other exemplary embodiment of the present invention is adapted into a touch panel to detect a touch location of a touch point. The touch panel comprises a substrate and at least one first-direction detecting device arranged on the substrate. Each first-direction detecting device comprises a first deformation sensor and a second deformation sensor. The touch-detecting method comprises: detecting a first variation because of a shape variation of the first deformation sensor in a first direction; detecting a second variation because of a shape variation of the second deformation sensor in the first direction; and determining a first-direction coordinate value of the touch point in the first direction according to the first variation and the second variation.

A display apparatus with touch function in accordance with other exemplary embodiment of the present invention is provided. The display apparatus comprises a substrate, a first deformation sensor, a second deformation sensor and a processor. The first deformation sensor generates a shape variation in a first direction because of generating the touch point, and provides a first variation because of the shape variation of the first deformation sensor. The second deformation sensor generates a shape variation in the first direction because of generating the touch point, and provides a second variation because of the shape variation of the second deformation sensor. The processor is electrically coupled to the first deformation sensor and the second deformation sensor, and is configured for judging the first-direction coordinate value according to a relation between the first variation and the second variation.

In an exemplary embodiment of the present invention, the display apparatus is a liquid crystal display apparatus, and the substrate is a thin-film transistor substrate or a color filter substrate of the liquid crystal display apparatus.

A display apparatus with touch function in accordance with other exemplary embodiment of the present invention is provided. The display apparatus comprises a substrate, a deformation pair arranged on the substrate, and a processing unit. The deformation pair generates shape variations when an object touches the display apparatus, and the processing unit is configured for detecting the shape variations of the deformation pair to judge a touch location of the object touching the display apparatus.

The present invention employs the deformation sensors arranged on the substrate as the sensors, and does not need to dispose the sensors on the whole touch panel. Thus, the touch panel of the present invention has a simple structure, a thin thickness and a low cost. In addition, the display apparatus of the present invention can directly dispose the deformation sensors on the substrate of the display apparatus, thus the display apparatus has the touch function without additionally disposing the touch panel. Therefore, the display apparatus of the present invention has a thin thickness, a simple structure, a low cost, a high penetration ratio, and other more excellent optical properties.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a touch panel in accordance with an exemplary embodiment of the present invention.

FIG. 2 is a circuit block diagram a circuit used for detecting a shape variation of a deformation sensor in accordance with an exemplary embodiment of the present invention.

FIG. 3 is a circuit block diagram a circuit used for detecting a shape variation of a deformation sensor in accordance with another exemplary embodiment of the present invention.

FIG. 4 is a schematic view of a method for achieving a first-direction coordination value of a touch point of a touch panel in accordance with an exemplary embodiment of the present invention.

FIG. 5 is a schematic view of a method for achieving a second-direction coordination value of a touch point of a touch panel in accordance with an exemplary embodiment of the present invention.

FIG. 6 is a flow chart of a touch-detecting method in accordance with an exemplary embodiment of the present invention.

FIG. 7 is a schematic view of a display apparatus in accordance with an exemplary embodiment of the present invention.

### DETAILED DESCRIPTION

Reference will now be made to the drawings to describe exemplary embodiments of the present touch panel, the present touch-detecting method thereof and the present display apparatus with touch function, in detail. The following description is given by way of example, and not limitation.

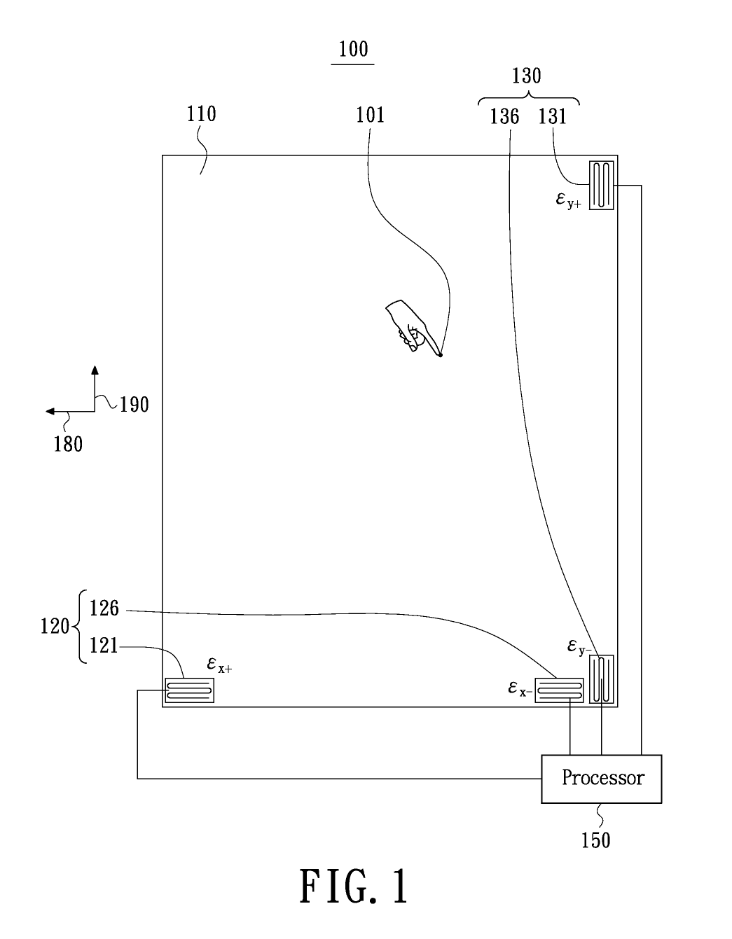

Referring to FIG. 1, which is a schematic view of a touch panel 100 in accordance with an exemplary embodiment of the present invention. The touch panel 100 is adapted for detecting a touch location of a touch point 101 generated by an object touching the touch panel 100. The touch panel 100 comprises a substrate 110, at least one first-direction detecting device 120, at least one second-direction detecting device 130 and a processor 150. The first-direction detecting device 120 is arranged at a first direction 180 of the substrate 110 (that is, the X direction in the exemplary embodiment) to detect a first-direction coordinate value of the touch point 101 (that is, the X coordinate value in the exemplary embodiment). The second-direction detecting device 130 is arranged at a second direction 190 of the substrate 110 (that is, the Y direction in the exemplary embodiment) to detect a second-direction coordinate value of the touch point 101 (that is, the Y coordinate value in the exemplary embodiment). The substrate 110 is a transparent substrate, such as a glass substrate. Of course, the substrate 110 may be a non-transparent substrate, such that the touch panel 100 may be applied into other fields. For example, the touch panel 100 may be used as a touch screen of a notebook computer.

The first-direction detecting device 120 comprises a first deformation sensor 121 and a second deformation sensor 126. Preferably, the first deformation sensor 121 and the second deformation sensor 126 are arranged at two opposite edges or corners of the substrate 110 along the first direction 180. The first deformation sensor 121 generates a shape variation in the first direction 180 because of generating the touch point 101, and provides a first variation εₓ₊ because of the shape variation thereof. The second deformation sensor 126 generates another shape variation in the first direction 180 because of generating the touch point 101, and provides a second variation εₓ₋ because of the shape variation thereof.

The second-direction detecting device 130 comprises a third deformation sensor 131 and a fourth deformation sensor 136. Preferably, the third deformation sensor 131 and the fourth deformation sensor 136 are arranged at two opposite edges or corners of the substrate 110 along the second direction 190. The third deformation sensor 131 generates a shape variation in the second direction 190 because of generating the touch point 101, and provides a third variation ε_{y+} because of the shape variation thereof. The fourth deformation sensor 136 generates another shape variation in the second direction 190 because of generating the touch point 101, and provides a fourth variation ε_{y-} because of the shape variation thereof. The first-direction coordinate value is determined by a relation between the first variation εₓ₊ and the second variation εₓ₋, such as a ratio therebetween. The second-direction coordinate value is determined by a relation between the third variation ε_{y+} and the fourth variation ε_{y-}, such as a ratio therebetween.

In a preferable exemplary embodiment, the first deformation sensor 121, the second deformation sensor 126, the third deformation sensor 131 and the fourth deformation sensor 136 may be strain gages or wiring structures, such as resistance strain gages. These deformation sensors 121, 126, 131 and 136 respectively generate the shape variations in the first direction or the second direction or both of the first direction and the second direction simultaneously. The first variation εₓ₊, the second variation εₓ₋, the third variation ε_{y+} and the fourth variation ε_{y-} correspond to the shape variations of the first deformation sensor 121, the second deformation sensor 126, the third deformation sensor 131 and the fourth deformation sensor 136 respectively, and are achieved by detecting the resistance-varying values of the deformation sensors respectively.

The processor 150 is electrically coupled to the first deformation sensor 121, the second deformation sensor 126, the third deformation sensor 131 and the fourth deformation sensor 136 respectively for receiving the first variation εₓ₊, the second variation εₓ₋, the third variation ε_{y+} and the fourth variation ε_{y-}, and determines the first-direction coordinate value and the second-direction coordinate value of the touch point 101 according to the first variation εₓ₊, the second variation εₓ₋, the third variation ε_{y+} and the fourth variation ε_{y-}. The following will describe methods for detecting the shape variation of the deformation sensor in detail.

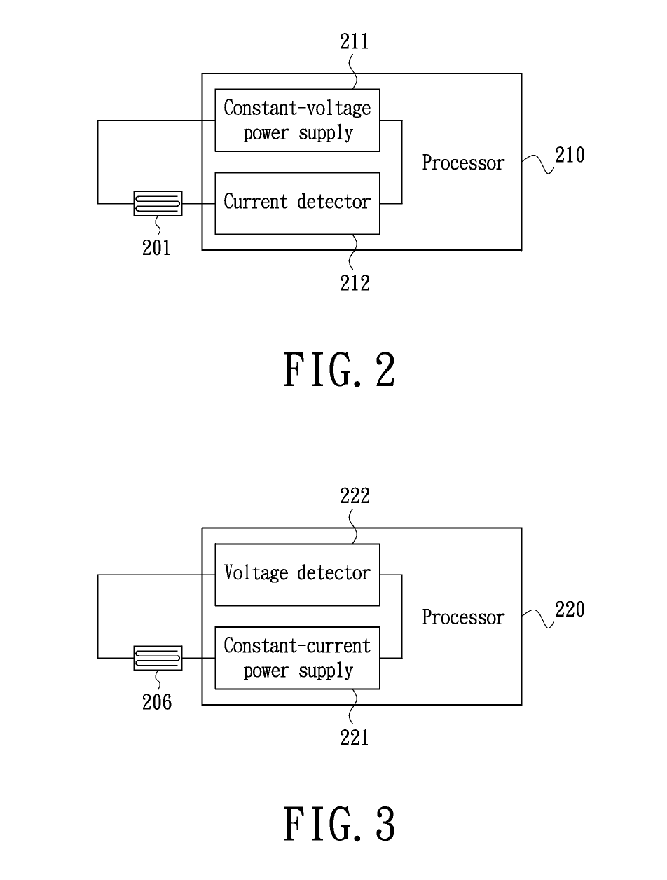

Refer to FIG. 2, which is a circuit block diagram of a processor used for detecting a shape variation of a deformation sensor in accordance with an exemplary embodiment of the present invention. In the exemplary embodiment, a deformation sensor 201 is electrically coupled to a processor 210, and the processor 210 employs a constant-voltage power supply 211 and a current detector 212 to detect the resistance-varying value of the deformation sensor 201. The constant-voltage power supply 211 is electrically coupled to the deformation sensor 201 to provide a stationary voltage to the deformation sensor 201, and the current detector 212 is electrically coupled to the deformation sensor 201 to detect a current passing through the deformation sensor 201. The processor 210 employs the constant-voltage power supply 211 and the current detector 212 to detect the resistance value of the deformation sensor 201. When the deformation sensor 201 generates the shape variation, the resistance value thereof varies correspondingly. Thus the processor 210 can detect the resistance-varying value of the deformation sensor 201 to achieve the shape variation of the deformation sensor 201. It should be noted that, although the constant-voltage power supply 211 and the current detector 212 are arranged in the processor 210 in the exemplary embodiment, they can be independently arranged out of the processor 210 in practice to be independent electronic components.

Refer to FIG. 3, which is a circuit block diagram of a processor used for detecting a shape variation of a deformation sensor in accordance with another exemplary embodiment of the present invention. In the exemplary embodiment, a deformation sensor 206 is electrically coupled to a processor 220, and the processor 220 comprises a constant-current power supply 221 and a voltage detector 222. The constant-current power supply 221 is electrically coupled to the deformation sensor 206 to provide a stationary current to the deformation sensor 206, and the voltage detector 222 is electrically coupled to the deformation sensor 206 to detect a voltage supplied on the deformation sensor 206. The processor 220 employs the constant-current power supply 221 and the voltage detector 222 to detect the resistance value of the deformation sensor 206. When the deformation sensor 206 generates the shape variation, the resistance value thereof varies correspondingly. Thus the processor 220 can detect the resistance-varying value of the deformation sensor 206 to achieve the shape variation of the deformation sensor 206. Similarly, although the constant-current power supply 221 and the voltage detector 222 are arranged in the processor 220 in the exemplary embodiment, they may be independently arranged out of the processor in practice to be independent electronic components.

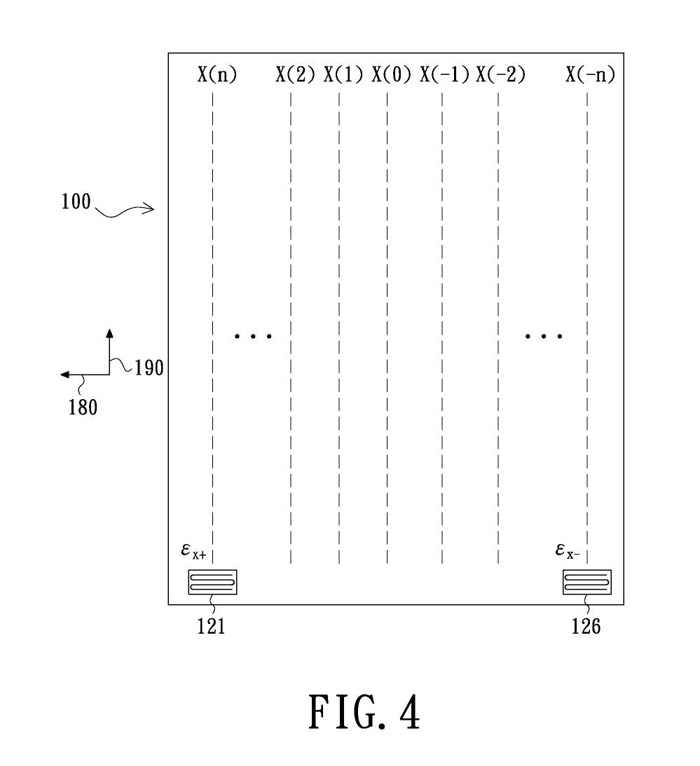

The following will describe a method for achieving the first-direction coordinate value and the second-direction coordinate value of the touch point in detail. Referring to FIGS. 1 and 4 together, wherein FIG. 4 is a schematic view of a method for achieving the first-direction coordination value of the touch point of the touch panel in accordance with an exemplary embodiment of the present invention. The touch panel 100 is defined to be consisted of a plurality of first dummy sensing lines X(n) . . . X(2), X(1), X(0) and X(−1), X(−2) . . . X(−n). The first dummy sensing lines X(n) . . . X(2), X(1), X(0) and X(−1), X(−2) . . . X(−n) are arranged in parallel with each other along the first direction 180 and extend along the second direction 190 respectively. The processor 150 as shown in FIG. 1 receives the first variation εₓ₊ provided by the first deformation sensor 121 and the second variation εₓ₋ provided by the second deformation sensor 126, and then processes them to achieve a ratio therebetween, such as εₓ₊/εₓ₋. Then, the processor 150 judges the first-direction coordinate value according to a prejudged coordinate-value corresponding list and the ratio εₓ₊/εₓ₋ of the first variation εₓ₊ and the second variation εₓ₋. In detail, when the ratio εₓ₊/εₓ₋ of the first variation εₓ₊ and the second variation εₓ₋ is equal to 1, the processor 150 judges that the touch point 101 is located at the first dummy sensing line X(0). When the ratio of εₓ₊/εₓ₋ the first variation εₓ₊ and the second variation εₓ₋ is more than 1, the processor 150 judges that the touch point 101 is located at one of the first dummy sensing lines X(0) to X(n). For example, when εₓ₊/εₓ₋=1.1, the processor 150 judges that the touch point 101 is located at the first dummy sensing line X(1). When the ration εₓ₊/εₓ₋ of the first variation εₓ₊ and the second variation εₓ₋ is less than 1, the processor 150 judges that the touch point 101 is located at one of the first dummy sensing lines X(0) to X(−n). For example, when εₓ₊/εₓ₋=0.9, the processor 150 judges that the touch point 101 is located at the first dummy sensing line X(−1).

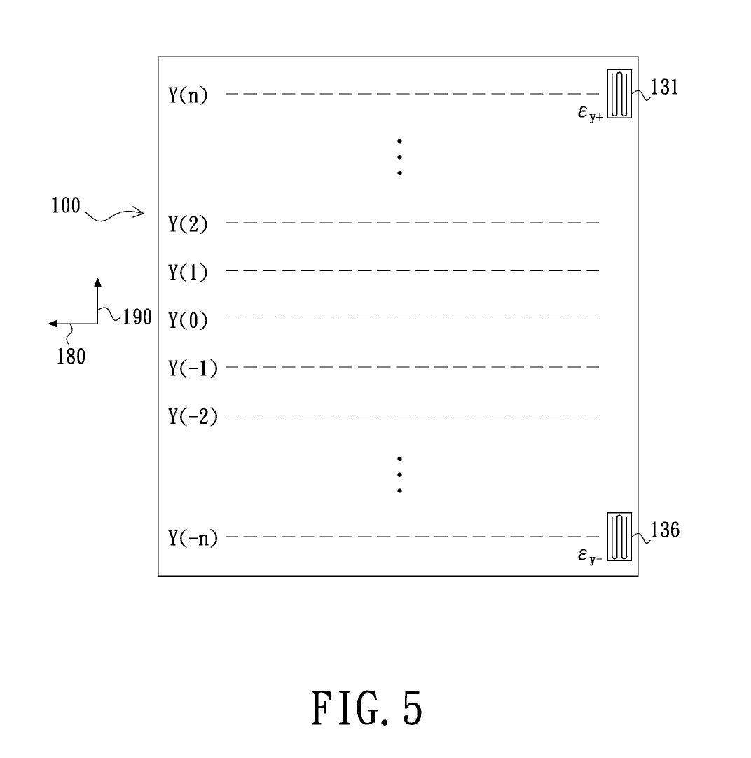

Similarly, please refer to FIGS. 1 and 5 together, wherein FIG. 5 is a schematic view of a method for achieving the second-direction coordinate value of the touch point of the touch panel in accordance with an exemplary embodiment of the present invention. The touch panel 100 may be defined to be consisted of a plurality of second dummy sensing lines Y(n) . . . Y(2), Y(1), Y(0) and Y(−1), Y(−2) . . . Y(−n). The second dummy sensing lines Y(n) . . . Y(2), Y(1), Y(0) and Y(−1), Y(−2) . . . Y(−n) are arranged in parallel with each other along the second direction 190 and extend along the first direction 180 respectively. The processor 150 as shown in FIG. 1 receives the third variation ε_{y+} provided by the third deformation sensor 131 and the fourth variation ε_{y-} provided by the fourth deformation sensor 136, and then processes them to achieve a ratio therebetween, such as ε_{y+}/ε_{y-}. Afterwards, the processor 150 judges the second-direction coordinate value of the touch point 101 according to the predetermined coordinate-value corresponding list and the ratio ε_{y+}/ε_{y-} of the third variation ε_{y+} and the fourth variation ε_{y-}. In detail, when the ratio ε_{y+}/ε_{y-} of the third variation ε_{y+} and the fourth variation ε_{y-} is equal to 1, the processor 150 judges that the touch point 101 is located at the second dummy sensing line Y(0). When the ratio ε_{y+}/ε_{y-} of the third variation ε_{y+} and the fourth variation ε_{y-} is more than 1, the processor 150 judges that the touch point 101 is located at one of the second dummy sensing lines Y(0) to Y(n). For example, when ε_{y+}/ε_{y-}=1.1, the processor 150 judges that the touch point 101 is located at the second sensing line Y(1). When the ratio ε_{y+}/ε_{y-} of the third variation ε_{y+} and the fourth variation ε_{y-} is less than 1, the processor 150 judges that the touch point 101 is located at one of the second dummy sensing lines Y(0) to Y(−n). For example, when ε_{y+}/ε_{y}=0.9, the processor 150 judges that the touch point 101 is located at the second dummy sensing line Y(−1).

That is, the touch panel of the present invention employs the shape-variations of a deformation pair consisted of two deformation sensor devices arranged on the substrate, which are generated when the object touching the touch panel, to judge the touch location of the object touching the touch panel. Except of judging the touch location in a single specific direction, furthermore, these designs can be used simultaneously to judge the touch location of the object in a two-dimensional plane of the touch panel.

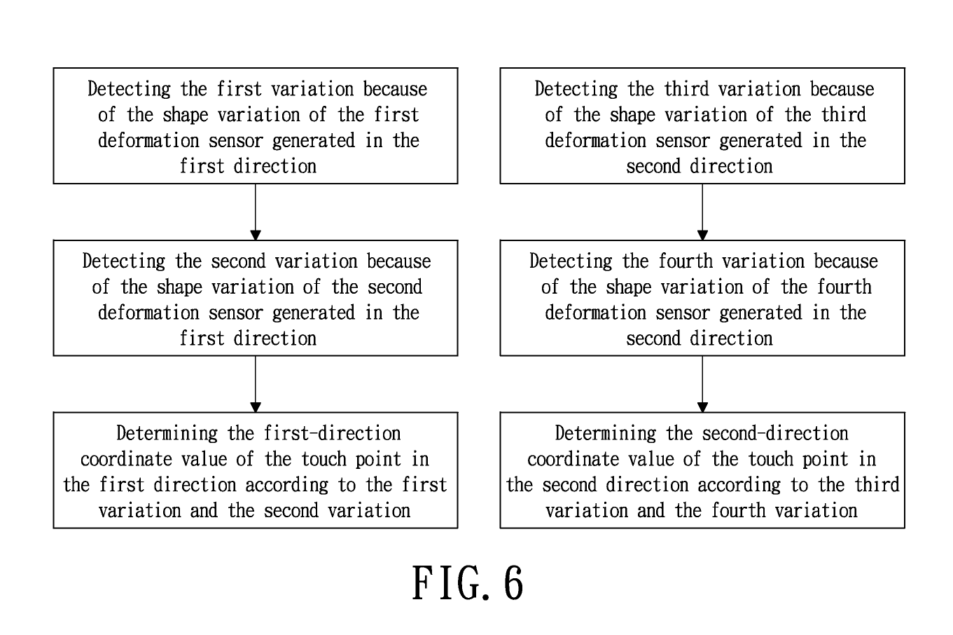

Please refer to FIG. 6, which is a flow chart of a touch-detecting method in accordance with an exemplary embodiment of the present invention. The touch-detecting method of the present invention is adapted into the touch panel 100 as shown in FIG. 1 to judge the touch location of the touch point 101. The touch-detecting method comprises: detecting the first variation εₓ₊ corresponding to the shape variation of the first deformation sensor 121 in the first direction 180; detecting the second variation εₓ₋ corresponding to the shape variation of the second deformation sensor 126 in the first direction 180; and determining the first-direction coordinate value of the touch point 101 in the first direction 180 according to the first variation εₓ₊ and the second variation εₓ₋.

In addition, the touch-detecting method further comprises: detecting the third variation ε_{y+} corresponding to the shape variation of the third deformation sensor 131 in the second direction 190; detecting the fourth variation ε_{y-} corresponding to the shape variation of the fourth deformation sensor 136 in the second direction 190; and determining the second-direction coordinate value of the touch point 101 in the second direction 190 according to the third variation ε_{y+} and the fourth variation ε_{y-}.

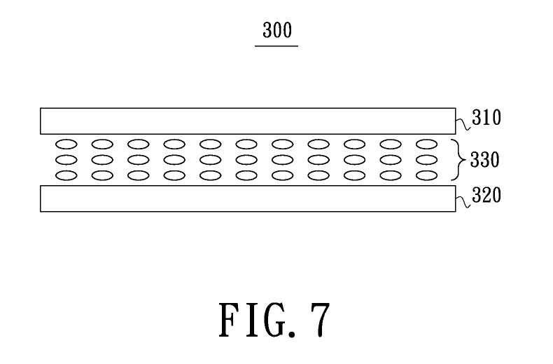

In addition, the present invention also provides a display apparatus with touch function. Please refer to FIG. 7, which is a schematic view of a display apparatus in accordance with an exemplary embodiment of the present invention. The display apparatus 300 may be a liquid crystal display, and comprises a thin-film transistor (TFT) substrate 310, a color filter (CF) substrate 320 and a liquid crystal layer 330 sandwiched therebetween. The TFT substrate 310 or the CF substrate 320 may have the structure of the touch panel 100 as shown in FIG. 1, thus the display apparatus 300 has the touch function. Furthermore, the first deformation sensor 121, the second deformation sensor 126, the third deformation sensor 131 and the fourth deformation sensor 136 as shown in FIG. 1 may be arranged on a surface of the TFT substrate 310 opposite to the CF substrate 320, or be arranged on a surface of the CF substrate 320 opposite to the TFT substrate 310. In another embodiment, the first deformation sensor 121, the second deformation sensor 126, the third deformation sensor 131 and the fourth deformation sensor 136 are arranged on an additional substrate and then attaching the additional substrate on the TFT substrate 310 or the CF substrate 320. Of course, it is obvious for one skilled in the arts that, the display apparatus 300 may be a liquid crystal display with the COA technology, which integrates the TFT and the CF into a same substrate.

In summary, the present invention employs the deformation sensors arranged on the substrate as the sensors, and does not need to dispose the sensors on the whole touch panel. Thus, the touch panel of the exemplary embodiment of the present invention has a simple structure, a thin thickness and a low cost. In addition, the display apparatus can directly dispose the deformation sensors on the TFT substrate or the CF substrate of the display apparatus, thus the display apparatus has the touch function without additionally disposing the touch panel. Therefore, the display apparatus of the exemplary embodiment of the present invention has a thin thickness, a simple structure, a low cost, and a high penetration ratio. Furthermore, the display apparatus of the exemplary embodiment of the present invention will not have an additional touch panel, thus the present invention will not have a problem of generating gaps between the additional touch panel and the display apparatus. Therefore, other optical properties of the display apparatus of the exemplary embodiment of the present invention are more excellent.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch panel configured for detecting a touch location of a touch point, the touch panel comprising:
a substrate; and
at least one first-direction detecting device arranged at a first direction of the substrate to detect a first-direction coordinate value of the touch point, and the first-direction detecting device comprising:
a first deformation sensor configured for generating and providing a first variation in the first direction due to the touch point; and
a second deformation sensor configured for generating and providing a second variation in the first direction due to the touch point;
wherein the first-direction coordinate value is determined by the first variation and the second variation.

2. The touch panel as claimed in claim 1, further comprising:
at least one second-direction detecting device arranged at a second direction of the substrate to detect a second-direction coordinate value of the touch point, and the second-direction detecting device comprising:
a third deformation sensor configured for generating and providing a third variation in the second direction due to the touch point; and
a fourth deformation sensor configured for generating and providing a fourth variation in the second direction due to the touch point;
wherein the second-direction coordinate value is determined by the third variation and the fourth variation.

3. The touch panel as claimed in claim 2, wherein the first-direction coordinate value is determined by a ratio of the first variation and the second variation, and the second-direction coordinate value is determined by a ratio of the third variation and the fourth variation.

4. The touch panel as claimed in claim 2, wherein the first deformation sensor, the second deformation sensor, the third deformation sensor and the fourth deformation sensor are strain gages or wiring structures.

5. The touch panel as claimed in claim 4, wherein the first variation, the second variation, the third variation and the fourth variation are shape variations of the first deformation sensor, the second deformation sensor, the third deformation sensor and the fourth deformation sensor respectively.

6. The touch panel as claimed in claim 5, wherein the shape variations of the first deformation sensor, the second deformation sensor, the third deformation sensor and the fourth deformation sensor are achieved by detecting resistance-varying values of the first deformation sensor, the second deformation sensor, the third deformation sensor and the fourth deformation sensor respectively.

7. The touch panel as claimed in claim 1, wherein the substrate is a glass substrate.

8. A touch panel configured for detecting a touch location of an object, the touch panel comprising:
a substrate; and
a deformation pair arranged on the substrate, the deformation pair generating shape variations in a first direction when the object touching the touch panel;
wherein the touch panel judges the touch location of the object touching the touch panel in the first direction according to a corresponding variation result generated by the shape variations of the deformation pair in the first direction.

9. The touch panel as claimed in claim 8, wherein the deformation pair comprises two deformation devices.

10. The touch panel as claimed in claim 8, further comprising another deformation pair arranged at a second direction of the substrate to generate shape variations in the second direction when the object touches the substrate, wherein the touch panel judges the touch location of the object touching the touch panel in the second direction according to a corresponding variation result generated by the shape variations of the deformation pair in the second direction.

11. The touch panel as claimed in claim 8, wherein the deformation pair is consisted of strain gages or wiring structures.

12. A touch-detecting method adapted into a touch panel to detect a touch location of a touch point, the touch panel comprising a substrate and at least one first-direction detecting device arranged on the substrate, and each first-direction detecting device comprising a first deformation sensor and a second deformation sensor, the touch-detecting method comprising:
detecting a first variation of a shape variation of the first deformation sensor in a first direction;
detecting a second variation of a shape variation of the second deformation sensor in the first direction; and
determining a first-direction coordinate value of the touch point in the first direction according to the first variation and the second variation.

13. The touch-detecting method as claimed in claim 12, wherein touch panel further comprises at least one second-direction detecting device arranged on the substrate, and each second-direction detecting device comprises a third deformation sensor and a fourth deformation sensor; the touch-detecting method further comprises:
detecting a third variation of a shape variation of the third deformation sensor generated in the second direction;
detecting a fourth variation of a shape variation of the fourth deformation sensor generated in the second direction; and
determining a second-direction coordinate value in the second direction according to the third variation and the fourth variation.

14. The touch-detecting method as claimed in claim 13, wherein the first-direction coordinate value is determined by a ratio of the first variation and the second variation, and the second-coordinate value is determined by a ratio of the third variation and the fourth variation.

15. The touch-detecting method as claimed in claim 13, wherein the first deformation sensor, the second deformation sensor, the third deformation sensor and the fourth deformation sensor are resistance strain gages or wiring structures, and the first variation, the second variation, the third variation and the fourth variation are resistance-varying values of the first deformation sensor, the second deformation sensor, the third deformation sensor and the fourth deformation sensor respectively.

16. A display apparatus with touch function, comprising:
a substrate;
a first deformation sensor configured for generating a shape variation in a first direction due to a touch point, and for providing a first variation of the shape variation of the first deformation sensor;
a second deformation sensor configured for generating a shape variation in the first direction due to the touch point, and for providing a second variation of the shape variation of the second deformation sensor;
a processor electrically coupled to the first deformation sensor and the second deformation sensor, and configured for judging the first-direction coordinate value according to a relation between the first variation and the second variation.

17. The display apparatus as claimed in claim 16, further comprising:
a third deformation sensor configured for generating a shape variation in a second direction due to the touch point, and for providing a third variation of the shape variation of the third deformation sensor; and
a fourth deformation sensor configured for generating a shape variation in the second direction due to the touch point, and for providing a fourth variation of the shape variation of the fourth deformation sensor;
wherein the processor is electrically coupled to the third deformation sensor and the fourth deformation sensor, and the processor judges the second-direction coordinate value according to a relation between the third variation and the fourth variation.

18. The display apparatus as claimed in claim 17, wherein the display apparatus is a liquid crystal display apparatus, and the substrate is a thin-film transistor substrate or a color filter substrate of the liquid crystal display apparatus.

19. The display apparatus as claimed in claim 18, wherein the first deformation sensor, the second deformation sensor, the third deformation sensor and the fourth deformation sensor are arranged on a surface of the thin-film transistor substrate opposite to the color filter substrate, or arranged on a surface of the color filter substrate opposite to the thin-film transistor substrate, or arranged on an additional substrate and then attaching the additional substrate on the thin-film transistor substrate or the color filter substrate.

20. A display apparatus with touch function, comprising:
a substrate;
a deformation pair arranged on the substrate, the deformation pair generating shape variations when an object touches the display apparatus; and
a processing unit configured for detecting the shape variations of the deformation pair to judge a touch location of the object touching the display apparatus.
